(19) United States
(12) Patent Application Publication
(10) Pub. No.: US 2026/0322768 A1
(43) Pub. Date: Oct. 15, 2026

(54) SHORTEST PATH BRIDGING AND ROUTING (SPBX) IN MULTI-AREA

(71) Applicant: Extreme Networks, Inc., San Jose, CA (US)

(72) Inventors: Constantin BARCARU, Brasov (RO); Roger LAPUH, Uesslingen (CH)

(73) Assignee: Extreme Networks, Inc., San Jose, CA (US)

(21) Appl. No.: 19/174,343

(22) Filed: Apr. 9, 2025

(51) Int. Cl. H04L 49/351; H04L 49/25; H04L 49/354

(52) U.S. Cl. CPC H04L 49/351; H04L 49/25; H04L 49/354

(57) ABSTRACT

Provided herein are systems and methods for facilitating communication of overlay Ethernet frames and IP packets from a set of virtual overlay networks over an underlay multi-area network. A multi-area network can have an edge node that receives an overlay packet from a host device. The edge node determines whether the overlay packet is a unicast packet or a BUM traffic. The edge node encapsulates the overlay packet into an underlay packet by adding an underlay header. The edge node forwards the IP packet to an inter-area router using a shortest path tree.

### CROSS-REFERENCE TO RELATED APPLICATIONS

This application is related to U.S. Patent Application No. ______ titled APPARATUS AND METHOD FOR VIRTUAL NETWORK SERVICES USING A SINGLE-AREA UNDERLAY NETWORK filed herewith (Attorney Docket No. 4264.7490000), and U.S. Patent Application No. ______ titled OVERLAY INTERNET PROTOCOL MULTICAST STREAMS OVER A MULTI-AREA VIRTUAL NETWORK filed herewith (Attorney Docket No. 4264.7510000), which are herein incorporated by reference in their entireties.

### FIELD

This disclosure relates generally to facilitating overlay Ethernet frames as well as overlay Internet Protocol (IP) packets from one or more virtual overlay networks over an underlay multi-area network.

### BACKGROUND

Existing Shortest Path Bridging Medium Access Control (MAC) mode (SPBM) only allows users to build a flat network in a single area. This puts a practical deployment limitation on the number of nodes that an SPB network can have. Many contemporary multi-area network fabrics use Ethernet Virtual Private Network (EVPN) technologies based on Multiprotocol Border Gateway Protocol (MP-BGP) and Protocol Independent Multicast (PIM) protocol, which makes multi-area network fabric configurations cumbersome to implement and computationally expensive to maintain.

As a result, systems, methods, and/or computer programs are needed to implement an improved network fabric that enables highly scalable and easy-to-deploy multi-area network fabrics for the SPB network.

### SUMMARY

Provided herein are system, method, and/or computer program aspects, and/or combinations and sub-combinations thereof, which facilitate communication of overlay unicast or multicast frames over an underlay network in accordance with Shortest Path Bridging and Routing (SPBX) using Internet Protocol (IP)-based encapsulation of data traffic.

Some aspects of this disclosure relate to systems and methods for facilitating the communication of overlay unicast or multicast frames over an underlay network including one or more network nodes. These elements of the SPBX network may be implemented in conjunction with an IP-based data plane and a single control plane for bridging overlay Ethernet frames as well as bridging and routing overlay IP unicast or multicast packets. In some aspects, the data plane may be an IPv4 or IPv6 data plane. The data plane may be programmed such that every overlay packet can be forwarded to reach one or more end nodes in the shortest network path and avoid looping. In this disclosure, the terms “end node” and “egress node” may be used interchangeably. In some aspects, the control plane is a single Intermediate System to Intermediate System (ISIS or IS-IS) routing protocol. In some aspects, the underlay network is a single-area network. In some aspects, the underlay network is a multi-area network. Some aspects of a multi-area SPBX underlay network are discussed herein.

The combination of an IP-based data plane and ISIS control plane provides a highly scalable multi-tenant, multi-area IP multicast solution supported by modern ASIC technologies and modernizes legacy solutions based on the IEEE 802.1ah networking standard. For example, the IP-based data plane may improve upon conventional multi-area network fabrics by increasing the scalability of the network. Specifically, the IP-based data plane may increase the overall capacity of individual components within the network and catalyze greater parallel processing and load balancing capabilities. Moreover, the ISIS control plane reduces the amount of helper protocols necessary to facilitate overlay IP multicast streams, advantageously reducing the computational resources needed to forward multicast packets across a multi-area network.

Some aspects of this disclosure relate to a computer-implemented method. The method includes receiving an overlay packet of the packet stream by an edge node in the first set of network nodes and from a first host device. The method further includes performing a unicast forwarding operation in response to determining that the overlay packet is a unicast packet intended for a second host device, by the edge node. The unicast forwarding operation includes determining, by the edge node, an IP address of an end node connected to a second host device and an inter-area router based on an underlay routing table lookup with the IP address of the end node connected to the second host device. The inter-area router may border a first area of a multi-area network and a second area of the multi-area network. In some aspects, the inter-area router may border more than two areas of a multi-area network. The unicast forwarding operation further includes determining a shortest path tree from the edge node to the inter-area router. The method further includes encapsulating, by the edge node, the overlay packet into a unicast underlay packet by adding an underlay header. In some aspects, adding is prepending. For example, the edge node may encapsulate the overlay packet into a unicast packet by prepending the underlay header to the overlay packet. The underlay header includes a media access control (MAC) address of the inter-area router as a destination MAC address, a MAC address of the edge node as the source MAC address, a destination IP address of the end node connected to the second host device, a source IP address of the edge node, backbone virtual local area network (BVLAN) value and a Virtual Network Identifier (VNI) of the virtual network. Throughout this disclosure, the terms “VNI,” “service identifier,” or comparable terms may be used interchangeably. The method further includes forwarding the unicast underlay packet to the inter-area router using a calculated shortest forwarding path.

In some aspects, the packet encapsulation may be achieved through Virtual eXtensivle Local Area Network (VXLAN), VXLAN encapsulation using IPv6 (VXLANv6), Generic Network Virtualization Encapsulation (GENEVE), or comparable IP-based encapsulation technologies.

In some aspects, the method further includes receiving a second unicast underlay packet from the inter-area router. The second unicast underlay packet is encapsulated by a second underlay header. The second underlay header includes a source MAC address of an inter-area router and a source IP address of the edge node originally receiving the second unicast packet, such as another ingress edge node. The underlay header may also have a destination MAC address of another inter-area router or an edge node connected to a receiving device. The destination IP address may be the edge node connected to the first host device receiving the second unicast underlay packet. The identifier value, such as a VNI of the virtual network (which may be a layer 2 or layer 3 instance), and BVLAN values may be equivalent to the underlay header described above.

In some aspects, the method further includes de-encapsulating the second unicast underlay packet by removing the second underlay header added to the original overlay packet or overlay frame. The method further includes forwarding the resulting overlay packet or frame from the edge node to the first host device.

In some aspects, the method further includes performing a broadcast, unknown unicast, and multicast (BUM) forwarding operation in response to determining that the overlay packet is a BUM traffic packet intended for flooding. The BUM forwarding operation includes determining a second shortest path forwarding tree for the first area based multicast destination nodes subject to the flooding. The second shortest path forwarding tree is identified by a nickname of the edge node, and a service identifier (ID) of a virtual network corresponding to the multi-area network. The service ID value may be a VNI value of a layer 2 virtual network. The BUM forwarding operation further includes encapsulating the overlay packet into a BUM underlay packet by adding an underlay header. In some aspects, adding means prepending. The BUM forwarding operation further includes forwarding the BUM underlay packet to the inter-area router using the second shortest path trees.

In some aspects, the underlay header of a BUM underlay packet may comprise a source backbone MAC address (BMAC-SA), a destination backbone MAC address (BMAC-DA), a BVLAN value, a backbone destination IP address (BIP-DA), a backbone source IP address (BIP-SA), and a service identifier of the virtual network, such as the VNI value of the layer 2 virtual network. The BMAC-SA may be a MAC address of the edge node receiving the BUM traffic. The BMAC-DA may be derived from a nickname and the VNI value specified by the edge node. A nickname may correspond to a predefined number of least significant bits of the IP address of the edge node. In some aspects, the predefined number of least significant bits may be 20 bits. The nicknames of all of the network nodes in environment 400b may be grouped based on an IP subnet address reflecting an area. The BIP-DA of the underlay header may refer to an IP multicast address corresponding the VNI of the layer 2 virtual network. The BIP-SA may be the IP address of the edge node.

In some aspects, the method further includes performing a BUM forwarding operation in response to determining that the overlay packet is a BUM traffic packet intended for flooding. The BUM forwarding operation includes determining a second shortest path forwarding tree for the first area based multicast destination nodes subject to the flooding. The second shortest path forwarding tree may be identified based on an IP address of the edge node, a multicast address, and a service identifier ID of a virtual network, such as a VNI value, corresponding to the multi-area network. The BUM forwarding operation further includes encapsulating the overlay packet into a BUM underlay packet by adding a BUM underlay header. In some aspects, the BUM underlay header is prepended to the underlay packet. The BUM forwarding operation further includes forwarding the BUM underlay packet to the inter-area router using the second shortest path trees.

In some aspects, the method further includes receiving route information of the second set of network nodes from the inter-area router. The underlay routing table is created at least based on the route information.

In some aspects, the link state routing protocol is an Intermediate System to ISIS link state protocol. In some aspects, the identifier of the shortest path forwarding tree includes a BVLAN.

Some aspects of this disclosure relate to a system for forwarding a packet stream across a multi-area network including a first area including a first set of network nodes and a second area including a second set of network nodes outside of the first area. The system includes an edge node in the first set of network nodes configured to perform operations. The operations include receiving an overlay packet of the packet stream by an edge node in the first set of network nodes and from a first host device. The operations further include performing a unicast forwarding operation in response to determining that the overlay packet is a unicast packet intended for a second host device, by the edge node. The unicast forwarding operation including determining an inter-area router based on an underlay routing table lookup with an IP address of the underlay end node connected to the second host device by the edge node. The inter-area router is included in the first area and the second area, and the underlay routing table is created by the edge node based on a link state routing protocol. The unicast forwarding operation further includes determining a shortest path from the edge node to the inter-area router. The operations further include encapsulating, by the edge node, the overlay packet into a unicast underlay packet by adding the underlay header. For example, the underlay header may be added to the overlay packet. The underlay header includes a destination MAC address of the inter-area router and an identifier of the shortest path forwarding tree, as well as the other underlay header elements enumerated above. The operations further include forwarding the unicast underlay packet to the inter-area router using then determined shortest path.

Some aspects of this disclosure relate to a non-transitory computer readable medium storing instructions for forwarding a packet stream across a multi-area network including a first area including a first set of network nodes and a second area including a second set of network nodes outside of the first area that, when executed by an edge node in the first set of network nodes, cause the edge node to perform operations. The operations further include performing a unicast forwarding operation in response to determining that the overlay packet is a unicast packet intended for a second host device, by the edge node. Here, the edge node may determine the underlay IP address of the end node connected to the second host device. The unicast forwarding operation includes determining an inter-area router based on an underlay routing table lookup with an IP address of the end node connected to the second host device, by the receiving edge node. The inter-area router is included in the first area and the second area, and the underlay routing table is organized by the edge node based on a link state routing protocol. The unicast forwarding operation further includes determining a shortest forwarding path from the edge node to the inter-area router. The operations further include encapsulating, by the edge node, the overlay packet into a unicast underlay packet by adding an underlay header. In such aspects, the underlay header may contain the same elements described above with respect to the BUM underlay packet header. The operations further include forwarding the unicast underlay packet to the inter-area router using the calculated shortest path.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE DRAWINGS

The accompanying drawings are incorporated herein and form a part of the specification.

FIG. 1 illustrates a block diagram of an exemplary single area network, according to some aspects.

FIG. 2 illustrates a block diagram of an exemplary multi-area network, according to some aspects.

FIG. 3 illustrates a block diagram of a control plane for a multi-area network, according to some aspects.

FIG. 4A illustrates a block diagram of an IP unicast multi-area network environment, according to some aspects.

FIG. 4B illustrates a block diagram of a broadcast, unknown unicast, and multicast (BUM) traffic within multi-area network environment, according to some aspects, according to some aspects.

FIG. 5 is a flow chart illustrating a method for forwarding an overlay packet over a multi-area network, according to some aspects.

FIG. 6 is a flow chart illustrating a method for bridging an underlay packet, according to some aspects.

FIG. 7 is a flow chart illustrating a method for routing an underlay packet in a transit area, according to some aspects.

FIG. 8 is a flow chart illustrating a method for routing the underlay packet in a destination area, according to some aspects.

FIG. 9 is a flow chart illustrating a method for forwarding the underlay packet to the destination host devise, according to some aspects.

FIG. 10 is a flow chart illustrating a method for forwarding a BUM traffic packet over a multi-area network, according to some aspects.

FIG. 11 is a flow chart illustrating a method for routing the BUM traffic packet over a multi-area network, according to some aspects.

FIG. 12 illustrates a diagram of a general-purpose computer that can be used to perform various aspects of the present disclosure, according to some aspects.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Provided herein are system, method, and/or computer program product aspects and/or combinations and sub-combinations thereof, which facilitate overlay Ethernet frames and overlay Internet Protocol (IP) packets from one or more virtual overlay networks over an underlay multi-area network.

The process of packet forwarding may define the effectiveness of multi-area network fabrics. Effective network fabrics can provide highly scalable multi-tenant solutions and implementations. A highly scalable multi-area network fabric is more capable of handling increased network traffic by enlarging the network in such a way that does not sacrifice the performance or stability of the network. Additionally, effective network fabrics require flexibility to adapt to changes in topology, especially in large multi-area deployments. Flexible network architecture can accommodate modifications of network areas, such as node movement or area redistributions, in a computationally efficient and streamlined process. Without a highly flexible network architecture, modifications to the network may lead to increased looping and packet loss. Moreover, highly scalable and flexible network fabrics allow for easier implementations with current application-specific integrated circuit (ASIC) technologies and service provider infrastructures. Thus, it is important to implement a network fabric capable of meeting the increased capacity demands imposed on networks and maximizing co-dependent technologies used for configuring a network fabric while maintaining a high level of performance and stability.

A network topology may be segmented into underlay and overlay networks. An underlay network may refer to the physical network infrastructure, such as Ethernet switches, nodes, routers, or a combination thereof, that forwards data packets from a host device to a destination host device. The overlay network may refer to a virtual network interconnecting end devices among the network topology.

In some aspects, a node as discussed in this disclosure can include a fabric node and/or a network node such as, but not limited to, a connection point inside and/or at the boundary of a network that can receive, transmit, create, and/or store data and/or other information. Some non-limiting examples of a node can include computers, routers, gateways, modems, printers, scanners, TVs, smart phones, Internet of Things (IoT) devices, bridges, switches, and the like. In some aspects, a host as discussed in this disclosure can include a personal computer (PC), a server, connected devices, TVs, smart phones.

Furthermore, a network topology segmented into overlay and underlay networks heavily relies on the data and control planes configured to forward a packet across the network. The data plane may refer to the network architecture that processes data transmissions between hosts. The control plane may refer to the network architecture that determines and stores routing and bridging decisions. These configuration characteristics are essential to the effectiveness of contemporary IP-based multi-tenant underlay solutions.

In some aspects, the overlay and underlay networks and the network elements contained therein may have separate IP addresses and media access control (MAC) addresses. For example, a packet or a frame of a unicast/multicast stream may specify customer MAC source and destination addresses (CMAC-SA and CMAC-DA, respectively), a customer virtual local area network (CVLAN) value, and overlay IP source and destination addresses. The corresponding CMAC addresses, CVLAN value, and overlay IP addresses may refer to the host and destination host devices detected on the access ports of the multi-area SPBX network.

In some aspects, the overlay packet may be encapsulated into an underlay packet. For example, a network node in the multi-area SPBX network may create the underlay packet by encapsulating the overlay packet based on a layer 3 virtual network, such as VXLAN or GENEVE. The resulting underlay packet may contain a backbone MAC source address (BMAC-SA) of the edge node receiving the unicast/multicast packet, a backbone MAC address of a destination node (BMAC-DA), a backbone IP source address (BIP-SA), a backbone IP destination address (BIP-DA), a backbone virtual local area network value (BVLAN) of the underlay network, and a virtual network identifier (VNI) value of the underlay network.

In some aspects, the multi-area SPBX underlay network may be split into various sub-network areas known as IP subnets. Subnets may contain a pre-defined grouping of network nodes and devices. Such nodes and devices are uniquely identified and grouped based on an IP address assigned to the underlay IP subnet. Therefore, the network nodes and devices within a particular underlay subnet have similar system IP addresses. The inter-area routers have multiple system IPs and system IPs for each attached area. In some aspects, a system ID value of a network node may correspond to a BMAC value of the same network node. Furthermore, each underlay IP subnet in the multi-area SPBX network may have a corresponding link state database (LSDB) instance in the ISIS-configured control plane. An LSDB may log and configure the forwarding decisions among the network nodes in a particular IP subnet. Therefore, in some aspects, network nodes within a particular first IP subnet, based on an LSDB of the first IP subnet, may know whether the BIP-DA corresponds to a network node inside or outside the first IP subnet. According to some aspects, the underlay IP subnets within the multi-area SPBX network may be grouped together by summarization. Summarization may include summarizing IP subnet addresses into a shorter prefix and advertising the resulting area—including the network nodes and services contained therein—as a single entity. Therefore, the SPBX network can enable a mesh-centric configuration of areas. This type of configuration allows for more flexible area designs without placing the stringent restrictions on inter-area routers found in many contemporary network solutions. Due to these characteristics, the multi-area SPBX network increases network scalability and avoids the computational and performance constraints of contemporary network topologies.

According to some aspects, the network nodes within the multi-area SPBX network may communicate with each other via a Network-to-Network-Interface (NNI). The NNI may be defined as an ISIS adjacency between network nodes. Moreover, an NNI may carry ISIS control protocol packets and underlay data traffic originating from the unicast/multicast stream.

In some aspects, the network nodes may also communicate with external devices, such as a host device, via a user-to-network interface (UNI). UNIs may be defined as end-point devices that serve as access interfaces to the multi-area SPBX network. An edge node in the multi-area SPBX network may utilize a UNI to receive data traffic originating from a host device initializing the unicast/multicast stream. Further, an end node in the multi-are SPBX network may utilize a UNI to forward data traffic originating from the unicast/multicast stream to a destination host device.

In some aspects, the multi-area SPBX network may contain one or more inter-area routers residing between neighboring underlay IP subnets. For example, inter-area routers may connect multiple network nodes in different IP subnet areas by routing traffic from one area to another. As such, the inter-area routers may have access to the LSDBs in the ISIS-configured control plane for the areas which it borders. Additionally, the inter-area routers may utilize an NNI to communicate with the network nodes in the areas which it borders.

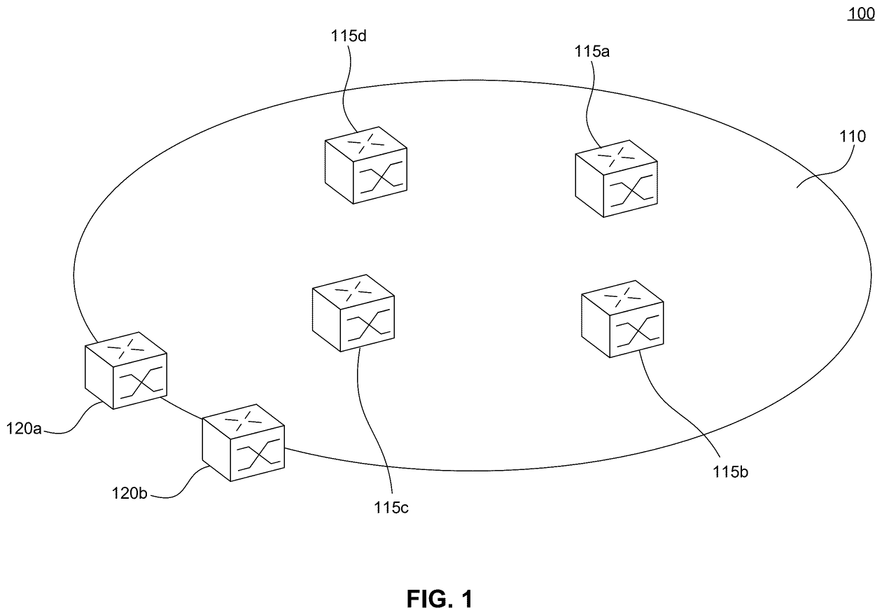

FIG. 1 illustrates a block diagram of an exemplary single area network environment 100, according to some aspects. The single area network environment 100 may be used in other contexts, as will be recognized by a person having ordinary skill in the art(s) reading this disclosure.

In some aspects, the single area network environment 100 may use a control plane configured with an Intermediate System to Intermediate System (ISIS or IS-IS) protocol. The ISIS protocol is a type of link state routing protocol. As such, all network nodes 115a-115d (collectively referred to as network node 115 or network nodes 115) and inter-area routers 120a and 120b (collectively referred to as inter-area router 120 or inter-area routers 120) may have a complete copy of an LSDB that defines the topology, services, network nodes 115, and inter-area routers 120 in the single area network environment 100. This allows for the network nodes 115 to have an identical view of the single area network environment 100 and compute the shortest forwarding paths in a consistent manner. The size of the LSDB has a direct impact on the resource requirement for all network nodes 115 (e.g., RAM, CPU power, ASIC capabilities, etc.). As a result, the size of the LSDB may define the upper and lower limits of the single area network environment 100 size and structure. In some aspects, the size and structure of the single area network environment 100 may define the total number of network nodes 115 and available network services (e.g., layer 2 services, layer 3 services, unicast/multicast services, etc.).

In some aspects, the single area network environment 100 may contain area 110. Area 110 may contain a set of network nodes 115, labeled collectively. The total number of network nodes 115 may be static or dynamic. Network nodes 115 may communicate and transmit data traffic amongst each other via an NNI. Network nodes 115 may be configured with an LSDB in the ISIS control plane that reflects the topology of area 110 and defines the forwarding decisions of the network devices of area 110. For example, network nodes 115 may share ISIS adjacencies that allow ISIS control packets and backbone IP traffic—such as underlay encapsulated unicast/multicast traffic—to be transmitted amongst each other. In some aspects, network nodes 115 may contemporaneously synchronize the LSDB based on receiving and forwarding data packets. Additionally, network nodes 115 may communicate with devices outside of area 110 via a UNI.

In some aspects, area 110 also has inter-area routers 120, labeled collectively. Inter-area routers 120a and 120b may communicate with the network nodes 115. For example, inter-area router 120a may receive data packets from network nodes 115c via an NNI. In some aspects, inter-area routers 120 may also communicate and forward data traffic with network nodes and devices residing outside of area 110. The inter-area routers 120 may route packets to external network nodes and devices via the NNI.

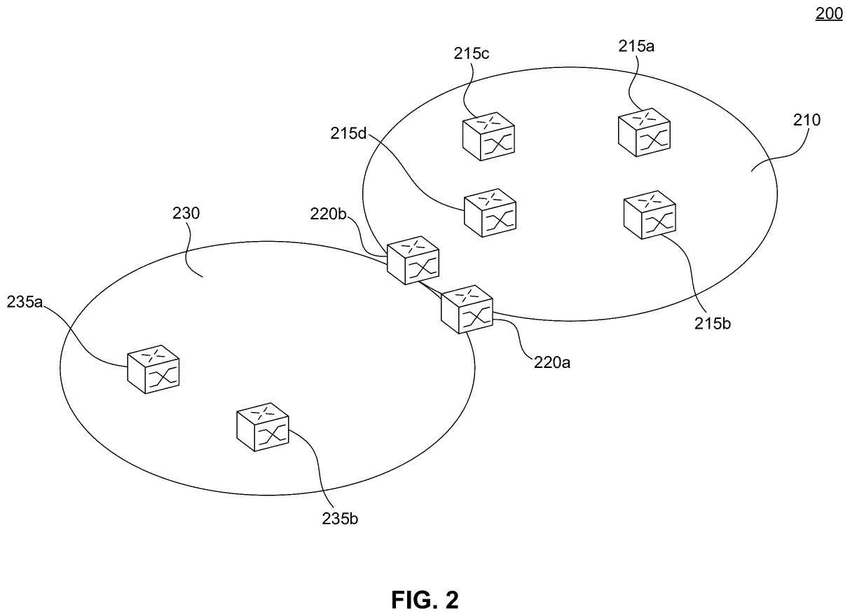

FIG. 2 illustrates a block diagram of an exemplary multi-area network environment 200, according to some aspects. Multi-area network environment 200 is exemplary. Multi-area network environment 200 will be used throughout this disclosure to illustrate the features of this disclosure. Multi-area network environment 200 may be used in other contexts, as will be recognized by a person having ordinary skill in the art(s) reading this disclosure.

In some aspects, multi-area network environment 200 may incorporate the functional characteristics of single area network environment 100, described in FIG. 1, combined with the addition of one or more network areas (also referred to herein as areas). For example, in some aspects, multi-area network environment 200 may contain area 210 and area 230. The aspects of multi-area network environment 200 are not intended to be limited to area 210 and area 230. Multi-area network environment 200 may contain several network segments greater than two, as will be recognized by one skilled in the art(s).

In some aspects, multi-area network environment 200 contains area 210 and area 230. Area 210, similar to area 110 described in FIG. 1, contains a first set of network nodes 215, labeled collectively. Network nodes 215 may communicate and forward data traffic amongst themselves in area 210 via an NNI. Network nodes 215 may contain a first ISIS LSDB instance that reflects the topology of area 210 and defines forwarding decisions among the network nodes 215 of area 210. Furthermore, network nodes 215 may share ISIS adjacencies with each other that allow ISIS control packets and backbone IP traffic—such as underlay encapsulated unicast/multicast traffic—to be transmitted over area 210. The LSDB of area 210 may be synchronized contemporaneously based on an event affecting the multi-area network environment 200 topology such as, but not limited to, the introduction of a new network device or node, the reception of a unicast/multicast stream, the intra-area reception and transmission of data packets, or a combination thereof. In some aspects, network nodes 215 may communicate with an external device outside of multi-area network environment 200 via a UNI. For example, network node 215a may receive an overlay data packet of a unicast/multicast stream originating from a host device outside of area 210.

In some aspects, multi-area network environment 200 contains a second area 230. Area 230 may contain a second set of network nodes 235, labeled collectively. For example, network nodes 235a and 235b may bridge or route underlay packets between each other via an NNI. Similar to network nodes 215 in area 210, network nodes 235 may receive and forward data traffic with devices external to multi-area network environment 200 via a UNI. Network nodes 235 may contain a second ISIS LSDB instance that reflects the topology of area 230 and defines forwarding decisions among the network nodes 235 of area 230. Furthermore, network nodes 235 may share ISIS adjacencies with each other that allow ISIS control packets and backbone IP traffic—such as underlay encapsulated unicast/multicast traffic—to be transmitted across area 230. The LSDB of area 230 may be synchronized contemporaneously based on an event affecting the multi-area network environment 200 topology such as, but not limited to, the introduction of a new network device or node, the reception of a unicast/multicast stream, the intra-area reception and transmission of data packets, or a combination thereof.

In some aspects, multi-area network environment 200 may contain inter-area routers 220, labeled collectively. For example, inter-area router 220a and inter-area router 220b may route underlay data traffic from area 210 into area 230 and from area 230 into area 210. Inter-area routers 220 may facilitate network communications from the network nodes 215 in area 210 and network nodes 235 in area 230 via an NNI. In some aspects, inter-area routers 220 may receive underlay packets from network nodes 215 in area 210 and network nodes 235 in area 230 via bridged or routed protocols. Inter-area routers 220 may forward underlay packets between area 210 and area 230 via a routing protocol. In some aspects, inter-area routers 220 may contain the LSDBs in the ISIS-configured control plane for each neighboring area. For example, inter-area routers 220 may contain the LSDBs of both area 210 and area 230.

In some aspects, network nodes 215 and network nodes 235 may perform intra-area forwarding operations by bridging underlay traffic. Bridging may refer to the process of forwarding an underlay packet to an underlay area egress point without altering the contents of the underlay packet header. For example, network node 215a may bridge an underlay packet to network node 215b by looking up the BMAC-DA and backbone VLAN (BVLAN) ID of the underlay packet header in the LSDB of area 210 and forwarding the underlay packet according to the ISIS shortest path calculation.

In some aspects, inter-area routers 220 may perform inter-area forwarding operations by routing the underlay packets from area 210 into area 230. For example, similar to the operations described above, inter-area router 220a may route an underlay packet from area 210 into area 230 by changing the BMAC-SA of the underlay packet header to correspond to the MAC address of inter-area router 220a. Additionally, inter-area routers 220 may de-increment a time-to-live (TTL) value associated with the underlay packet by one as the packet is routed from area 210 into are 230.

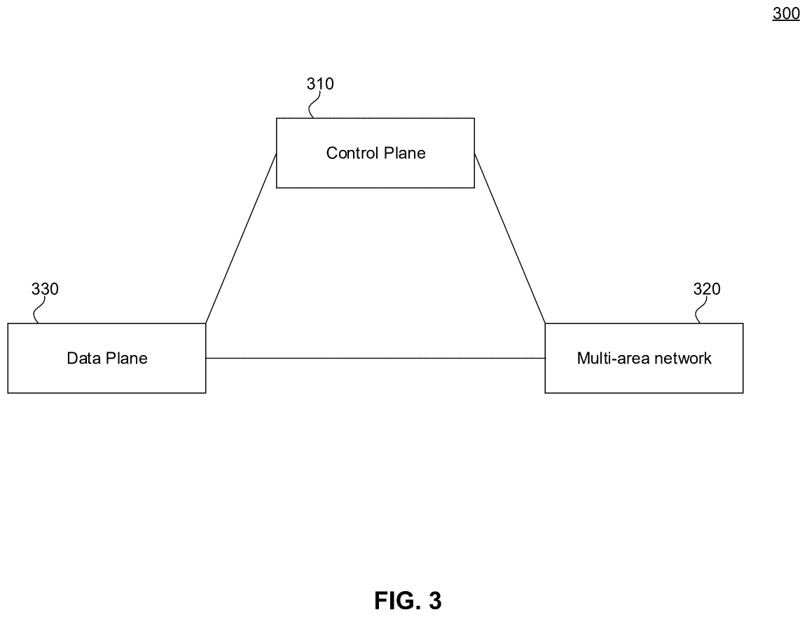

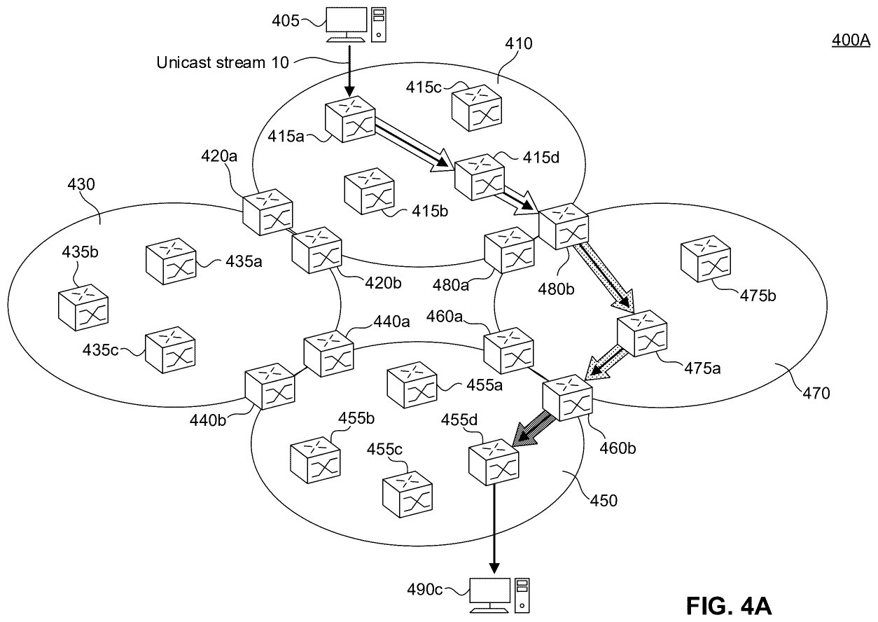

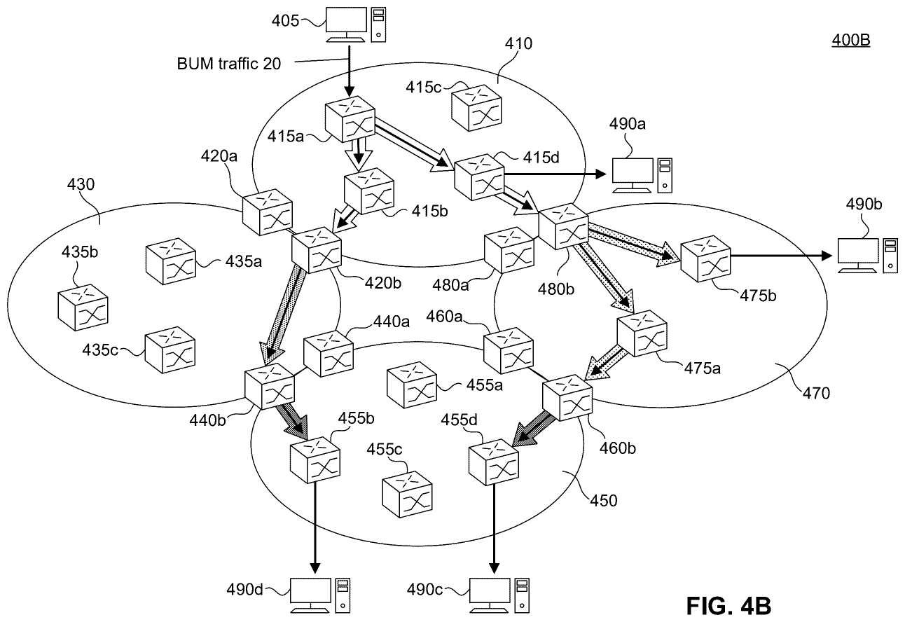

FIG. 3 illustrates a block diagram for a control plane system 300 implemented in a multi-area network, according to some aspects. The control plane system 300 has a control plane 310 that connects to a data plane 330 and a multi-area network 320. The multi-area network 320 may reflect the multi-area network aspects described herein, such as the multi-area network environment 200 described in FIG. 2 and/or the unicast/multicast multi-area network environments 400a and 400b described in FIGS. 4A and 4B, respectively. The connection between multi-area network 320, data plane 330, and control plane 310 can be over a fabric technology. In some aspects, the fabric technology allows for communication or connection between entities with an established IP and MAC Address. In some aspects, the fabric technology allows for communication or connection between entities without an IP connection.

Data plane 330 can be data processing elements, such as some or all of a computer system (e.g., computer system 1200). In some aspects, data plane 330 can store state information about the multi-area network 320, its topology, services available, IP-based virtualization data, and MAC information. In some aspects, the data plane 330 may be based on a layer 3 communication protocol, such as IPv4 or IPv6. Data plane 330 may process network operations among the multi-area network 320 by supporting overlay traffic encapsulation processes. In some aspects, the encapsulation processes may include VXLAN encapsulation using IPv4 or IPv6 or Generic Network Virtualization Encapsulation (GENEVE).

In some aspects, the control plane 310 may be a single instance of an ISIS protocol. The control plane 310 may receive information from data plane 330 and send out update information to multi-area network 320. In some aspects, the packets analyzed or processed in the data plane 330 can be used to program tables of information for later use and send the information to the control plane 310. For example, the tables of information may include routing tables and LSDBs. The network elements within the multi-area network 320 may utilize the control plane 310 to form ISIS adjacencies with neighboring network elements. The control plane 310 may compute the shortest path from one network element to another network element in the multi-area network 320. For example, the control plane 310 may compute the shortest forwarding path among network elements by generating a shortest-path forwarding (SPF) tree corresponding to a unicast/multicast stream.

In some aspects, control plane 310 can be configured to send messages to data plane 330 or multi-area network 320. In some aspects, the messages can be sent by certain protocols, such as inter-process communication (IPC) protocols or remote procedure call (RPC) protocols.

FIG. 4A illustrates a block diagram of an IP unicast multi-area network environment 400a according to some aspects. Like the multi-area network environment 200 described in FIG. 2, multi-area network environment 400a may be segmented into multiple areas such as underlay IP subnets. In some aspects, multi-area network environment 400a may be segmented into a first area 410, a second area 430, a third area 450, and a fourth area 470. Area 410 may contain a first set of network nodes 415 (labeled collectively), area 430 may contain a second set of network nodes 435 (labeled collectively), area 450 may contain a third set of network nodes 455 (labeled collectively), and area 470 may contain a fourth set of network nodes 475 (labeled collectively). Multi-area network environment 400a will be described with reference to the elements enumerated in FIG. 3; however, multi-area network environment 400a is not limited to these example aspects.

In some aspects, the areas of environment 400a are assigned their own range of underlay subnet IP addresses. For example, area 410 may have an underlay subnet IP address of 10.1.0.0/24. For example, area 430 may have an underlay subnet IP address of 10.2.0.0/24. For example, area 450 may have an underlay subnet IP address of 10.3.0.0/24. For example, area 470 may have an underlay subnet IP address of 10.4.0.0/24. Network nodes 415 may be assigned unique system IP addresses commensurate with the underlay subnet IP address of area 410 with a distinct host address value. For example, network node 415a may be assigned a system IP address of 10.1.0.1/24, network node 415b may be assigned a system IP address 10.1.0.2/24, network node 415c may be assigned a system IP address 10.1.0.3/24, and network node 415d may be assigned a system IP address 10.1.0.4/24. The network nodes of environment 400a may also be given a system ID representative of the network node's MAC address.

In some aspects, network nodes 415, 435, 455, and 475 in environment 400a may have similar functional characteristics of network nodes 215 and 235 in multi-area network environment 200, as described in FIG. 2. In some aspects, the access port of an edge node (e.g., network node 415a) may detect unicast stream 10 introduced into area 410. Network node 415a may identify an end node, such as network node 455d, based on the BIP-DA of the underlay header. As a result, the overlay stream is forwarded based on a shortest-path calculated by the LSDB and routing table of a particular area, such as area 410. The VNI value may, in aspects which unicast stream 10 is bridged over environment 400a, represent the bridge domain, such as a layer 2 virtual network. The VNI value may be determined by network node 415a based on the ingress port attributes, CVLAN attributes, or a combination thereof. In some aspects which unicast stream 10 is routed over environment 400a, the VNI value is an identifier that based on virtual routing and forwarding. In some aspects, VNI values of environment 400a are configured by a user engaging with the multi-area network.

In some aspects, unicast stream 10 originating from host device 405 may be an overlay unicast stream containing an overlay frame. The contents of the overlay frame may correspond to the data transmitted by unicast stream 10, such as CMAC-SA, CMAC-DA, and CVLAN values from a payload Ethernet frame. In some aspects, in which unicast stream 10 is bridged over environment 400a, such as network nodes 415, the destination host device of unicast stream 10 may be determined by the {CMAC-DA, CVLAN} of the respective overlay Ethernet frame. In some aspects, in which unicast stream 10 is routed over environment 400a, destination host device 490c may correspond to an end node either inside or outside of the originating network area. For example, an end node corresponding to destination host device 490c may be network node 455d. Since the end node functionally provides access interface to end-point devices, the end node can be thought of as a special type of edge node.

In some aspects, any network device in environment 400a may receive the unicast stream 10. For example, network node 415a may receive an overlay packet from unicast stream 10 originating from host device 405. In some aspects, network node 415a encapsulates the overlay packet into an underlay packet to be forwarded across the underlay mesh network environment 400a. The encapsulation may be based on a layer 3 virtual network, such as VXLAN or GENEVE. The underlay packet may contain the BMAC-SA corresponding to the edge node and inter-area routers, such as network node 415a and inter-area routers 480b and 460b, the BIP-SA corresponding to network node 415a, a BMAC-DA, a BIP-DA corresponding to network node 455d, a BVLAN ID, and a VNI value.

In some aspects, environment 400a may be configured to create a BVLAN ID for area 410 by a hashing algorithm or comparable unique identifier generator function. An edge node, such as network node 415a, may assign the BVLAN ID to the underlay packet once the overlay packet of unicast stream 10 is received and encapsulated.

In some aspects, the VNI value is derived from a pre-defined range of network nodes in environment 400a. The edge node, such as network node 415a, may associate a VNI value per IP unicast stream introduced to environment 400a. A VNI value may be based on a bridged virtual network domain or a distributed virtual router domain. In some aspects, a range of VNI values of environment 400a are configured by a user engaging with the multi-area network. Therefore, network node 415a may associate one VNI value with unicast stream 10 and another VNI value for a subsequent unicast stream.

In some aspects, the BIP-DA of the underlay packet may be derived by the edge node, such as network node 415, based on a backbone IP address (e.g., system IP) of the end node. The MAC address of the end node may be identified based on the underlay intra-area IP host table programmed by ISIS-configured control plane 310. For example, a separately configured MAC address of the end node may be identified by the ISIS-configured control plane 310 and distributed to an LSDB contained therein.

In some aspects, the BMAC-DA may be derived by the edge node and inter-area routers, such as network nodes 415a, 480b, and 460b based on a backbone MAC address (e.g., system ID) of the inter-area routers or end node. The MAC address of the inter-area routers may be determined based on the underlay routing table programmed by ISIS-configured control plane 310. For example, the BIP-DA of the end node may be determined based on the L2 table CMAC-DA lookup. The resulting BIP-DA determination may indicate the corresponding BMAC-DA in which frames from unicast stream 10 may be forwarded to.

In some aspects, network node 415a may create a shortest-path forwarding (SPF) tree based on the LSDB in the ISIS-configured control plane 310. For example, network node 415a may utilize the LSDB instance in the control plane 310 for area 410 to calculate a shortest forwarding path to receiving nodes 490. The SPF tree may utilize a series of forwarding nodes among areas 410, 470, and 490 to forward the underlay packet to destination host device 490c.

In some aspects, environment 400a may contain a set of inter-area routers that border the segmented underlay areas of the network environment 400a (e.g., inter-area routers 420, 440, 460, and 480 (labeled collectively)). The inter-area routers of environment 400a may refer to a collection of routers. For example, inter-area router 480b may reside between area 410 and area 470. Furthermore, inter-area router 480b may receive an underlay packet from network node 415d via an NNI and route the packet to one of the network nodes 475 in area 470. Based on the reception of the underlay packet, inter-area router 480b may route the underlay packet by changing the BMAC-SA of the underlay packet to be its own system ID. The system ID of inter-area router 480b may reflect the MAC address of inter-area router 480b. The other inter-area routers of environment 400a may be configured to perform functions identical to those of inter-area router 480b.

In some aspects, an inter-area router in environment 400a may understand the network topology of environment 400a, such as the segmented areas within a multi-area network 320. For example, inter-area router 480b may advertise itself, via the LSDB of area 410 in an ISIS-configured control plane 310, as a viable next-hop into area 470. Furthermore, inter-area router 480b may determine a shortest bridged path to forward underlay traffic into area 450 by querying the LSDB of area 470 in the ISIS-configured control plane 310. The shortest bridged path determined by inter-area router 480b may correspond to the SPF tree paths of unicast stream 10. In some aspects, boundary routers may advertise each connected area as underlay routing table entries into the LSDBs of all other connected areas. Boundary routers also re-distribute underlay routes from other boundary routers connected to more distant areas. The underlay routing table entries may be referenced as route information. In other words, the underlay routing table is created based on the route information.

In some aspects, the end nodes of environment 400a (e.g., network node 455d) de-encapsulate the overlay packet within the underlay packet. The end nodes may de-encapsulate the overlay packet by removing the underlay header added to the overlay packet. For example, network node 455d may remove the underlay header within the underlay packet. Additionally, network node 455d may perform a layer 2 table lookup with the CMAC-DA address of the destination host device 490c and the VNI of the layer 2 virtual network determined based on ingress port, CVLAN attributes or a combination of the two. A matching entry will point to a UNI that specifies how the de-encapsulated overlay packet may be forwarded to destination host device 490c. Therefore, network node 455d may only forward the overlay packet and the contents therein to destination host device 490c.

In some aspects, an inter-area router in environment 400a may be able to calculate a distance metric between intra-and inter-area network nodes. For example, inter-area router 480b may calculate a distance metric for each network node 415 in area to network nodes 475 in area 470 and/or to network nodes 455 in area 450. In some aspects, the distance metric may be representative of a path cost. A path cost may indicate a network distance to forward underlay traffic among the various network nodes in environment 400a. In some aspects, the lowest distance metric reflects the shortest-path. In some aspects, the distance metric may also be defined by an SPF tree corresponding to an overlay IP multicast stream. For example, the SPF tree relating to unicast stream 10 may illustrate distance metrics from its root node, network node 415a, to the destination host device 490c. In some aspects, an inter-area router in environment 400a may input its calculated distance metrics into an LSDB of an ISIS-configured control plane 310. For example, inter-area router 480a may input the distance metrics corresponding to network nodes 415 into the LSDB of area 410.

In some aspects, an inter-area router in environment 400a may search an IP routing table for the BIP-DA corresponding to an end node in an underlay packet. For example, inter-area router 480b, based on receiving an underlay packet corresponding to unicast stream 10, may search its own routing table for the BIP-DA within the underlay packet. In some aspects, inter-area router 480b may then determine that the BIP-DA of the underlay packet corresponds to an area outside of the areas which it neighbors, such as area 450. Based on this determination, inter-area router 480b may determine an appropriate next-hop inter-area router (e.g., inter-area router 460b) to forward the underlay packet to.

In some aspects, an inter-area router in environment 400a may receive a hashed path corresponding to a BVLAN value of the underlay packet. The hashed path may refer to a path derived among multiple equal cost paths by a hashing algorithm. For example, inter-area router 480b may receive a hashed path reflecting a BVLAN value assigned to unicast stream 10 in conjunction with an underlay packet from network node 415d. The hashed path may be determined by a hashing algorithm and contain an outgoing NNI and BVLAN value, which will enable inter-area router 480b to perform a routing action on the underlay packet. Therefore, based on receiving the hashed path and underlay packet, inter-area router 480b may forward the underlay packet to one of the network nodes 475 in area 470 in accordance with the hashed path.

FIG. 4B illustrates a block diagram of a broadcast, unknown unicast, and multicast (BUM) traffic within multi-area network environment 400b according to some aspects. In some aspects, environment 400b retains the same multi-area network elements and their corresponding functional capabilities as enumerated in environment 400a of FIG. 4A.

In some aspects, BUM flooding may be a multicast steam caused by process of sending BUM traffic 20 to the network nodes of environment 400b reflected by a VNI based shortest-path tree, except for the originating edge node (e.g., network node 415a). For example, an unsuccessful lookup may result in flooding to all UNIs in environment 400b reflected by the VNI based shortest-path tree, egressing one copy of the frame per member in environment 400b logical port and each one following the rules defined by the destination UNI configuration. The egress replication may be used to generate additional copies of the customer frame throughout the network fabric and all the way to relevant egress logical ports. As shown in FIG. 4B, BUM traffic 20 from host device 405 is introduced in environment 400b to illustrate the features of this disclosure further. Additionally, environment 400b will be described with reference to the elements enumerated in FIG. 3; however, environment 400b is not limited to these example aspects.

In some aspects, environment 400b may reflect an instance in which a plurality of streams is introduced into a multi-area network 320. For example, area 410 in environment 400b may receive two distinct streams (e.g., unicast stream 10 and BUM traffic 20) from two different host devices.

In some aspects, BUM traffic 20 originating from host device 405 may be a multicast stream containing an overlay packet. The contents of the overlay packet may correspond to the data transmitted by BUM traffic 20, such as CMAC-SA, CMAC-DA, and CVLAN values from a payload Ethernet frame. Furthermore, the overlay packet of BUM traffic 20 may specify a group of receiving nodes 490, labeled collectively. The receiving nodes 490 may correspond to an end node either inside or outside of the originating network area. For example, an end node in environment 400a may be one of network nodes 415d, 455b, 455d, or 475b.

In some aspects, any network device in environment 400b may receive BUM traffic 20. For example, network node 415a may receive an overlay packet from BUM traffic 20 originating from host device 405. In some aspects, network node 415a encapsulates the overlay packet into an underlay packet to be forwarded across the underlay mesh network environment 400b. The encapsulation may be based on a layer 3 virtual network, such as VXLAN or GENEVE. The underlay packet may contain the BMAC-SA corresponding to the end node and inter-area routers, such as network nodes 415a, 420b, 440b, 460b, and 480b, the BIP-SA corresponding to network node 415a, a BMAC-DA, a BIP-DA corresponding to network node 455d, a BVLAN ID, and a VNI value.

In some aspects, the content of the underlay packet may include the content described in FIG. 4A. In some aspects relating to overlay IP multicast traffic, the BIP-DA of the underlay packet may be derived by the edge node, such as network node 415a, based on the VNI value allocated to the multicast stream, such as BUM traffic 20. The BMAC-DA may be derived by the edge node, such as network node 415a, based on a nickname and VNI. A nickname may correspond to a predefined number of least significant bits of an IP address of the edge node. In some aspects, the predefined number of least significant bits may be 20 bits. The nicknames of all of the network nodes in environment 400b may be grouped based on an IP subnet address reflecting an area. In some aspects, the BMAC-DA may be derived based on the multicast BIP-DA. The inter-area routers have multiple nicknames for each attached area.

In some aspects, the SPF tree relating to BUM traffic 20 may be associated with a nickname and VNI value. In some alternative aspects, the SPF tree may be associated with a Source Group Virtual Local Area Network (SGV) value corresponding to an edge node (e.g., network node 415a). The SGV value may refer to a data array containing a BIP-SA of the edge node, an IP multicast group IP address derived from a VNI of the edge node, and a virtual local area network (VLAN) value of the edge node. In some aspects, the VLAN value may be a BVLAN which reflects the SPF from one or more multiple equal cost paths, such as one or more shortest-path trees. Furthermore, the SGV value represents a key value in which a 3-tuple lookup is performed to determine the end nodes of the BUM traffic 20. In some aspects, environment 400b may be configured to assign a nickname and VNI value or SGV value to the SPF tree based on a total number of network nodes. For example, an edge node may assign the SPF tree a nickname and VNI value if the total number of network nodes in environment 400b is less than 1 million. Alternatively, the edge node may assign the SPF tree an SGV value if the total number of network nodes in environment 400b.

In some aspects, the inter-area routers of environment 400b (e.g., inter-area routers 420, 440, 460, and 480 (labeled collectively)) have the same functional capabilities as described in FIG. 4A. The inter-area routers of environment 400b may contain an LSDB instance in the ISIS-configured control plane 310 for the areas in which they border. For example, inter-area router 420a may contain an LSDB instance corresponding to both areas 410 and 430. Each time a new multicast stream is introduced into environment 400b, inter-area router 420a may announce the multicast stream into its LSDB instances. For example, inter-area router 420a may announce unicast stream 10 into the LSDB of area 430. Inter-area router 420a may announce BUM traffic 20 via a TLV encoding scheme. The TLV data object may include the values described in FIG. 4A. In some aspects, all BUM traffic, such as BUM traffic 20, belonging to the same virtual network instance of environment 400b may use the same computed SPF tree based on said TLV data object. Furthermore, inter-area router 420a may announce BUM traffic 20 into the LSDB of area 430 via a second TLV data object. Additionally, inter-area router 420a may advertise to the LSDB instance of area 410 that it is a viable next-hop into the area 430. In some aspects, inter-area router 420a may perform data traffic operations through an implemented control plane system 300 and the elements contained therein. In some aspects, inter-area routers may use ISIS defined TLVs to redistribute local and remote area services (L2 services, overlay routes & IP multicast streams) across the area boundary. In some aspects, inter-area routers may add TLVs corresponding to redistributed services to their own label swapping protocols (LSPs).

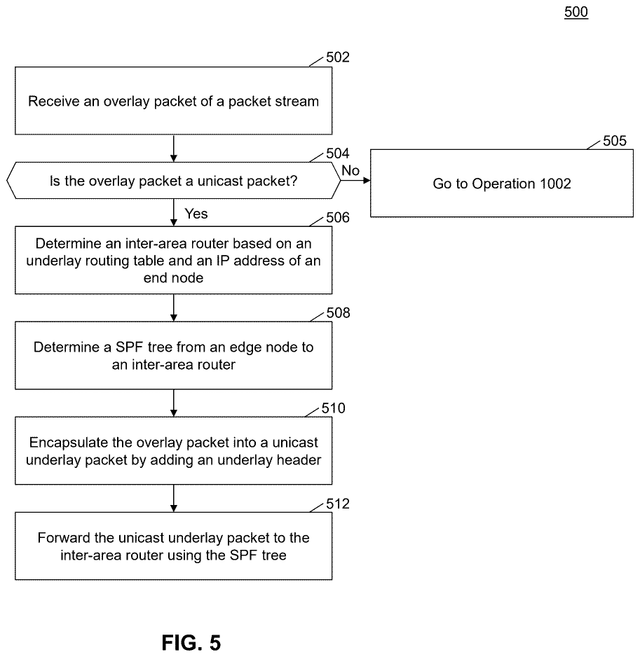

FIG. 5 is a flow chart illustrating a method 500 for forwarding an overlay packet over a multi-area network, according to some aspects. Method 500 can be employed in aspects of the multi-area networks described herein, such as multi-area network environments 400a and 400b. Method 500 will be described with reference to the elements enumerated in FIGS. 3, 4A, and 4B; however, method 500 is not limited to these example aspects.

In some aspects, method 500 can be implemented to forward packet streams as described in multi-area network environments 400a and 400b. In some aspects, a multi-area network environment, such as environments 400a and 400b, may contain a first set of network nodes inside a first area and a second set of network nodes inside a second area, such as areas 410 and 430, respectively. In some aspects of method 500, environment 400a may contain a third set of network nodes inside a third area outside of the first and second areas, such as area 450, and a fourth set of network nodes in a fourth area outside of the first, second, and third areas, such as area 470.

In some aspects, forwarding the overlay packet over a multi-area network is done by routing using the backbone IP underlay header (e.g., source IP (SRCIP)/destination IP (DSTIP)/VNI). Every time underlay routing occurs, the underlay header time-to-live value is decreased by 1. In some aspects, forwarding the overlay packet over a multi-area network occurs in the following steps: 1) originating area forwarding, 2) inter-area router forwarding, 3) transit area forwarding, and 4) destination area forwarding. The methods 500 and 600 (explained below) may explain the originating area forwarding. The methods 700 (explained below) and 800 (explained below) may explain the inter-area router forwarding. The method 600 may also explain the transit area forwarding. The methods 800 and 900 (explained below) may explain the destination area forwarding.

At 502, an overlay packet of a packet stream is received. For example, an edge node may receive an overlay packet of a packet stream. For example, an overlay packet of a stream, such as unicast stream 10 or BUM traffic 20, is received by an edge node, such as network node 415a in area 410, from host device 405. Network node 415a, the node that received the overlay packet from host device 405, may be referred to as an Ingress backbone edge bridge (BEB). The area to which the Ingress BEB belongs (area 410) may be referred to as the originating area. In contrast, the area to which the destination host device of the overlay packet belongs may be referred to as the destination area, and the area between the origin area and the destination area may be referred to as the transit area.

In some aspects, Ethernet frames of the packet stream ingressed on UNIs may be classified into a corresponding virtual network, which may be based on a layer 2 or layer 3 instance, based on UNI definition criteria. Network node 415a will be used as an exemplary edge node to illustrate the features of method 500. However, method 500 is not limited to this exemplary aspect. The header of the Ethernet frame may include CMAC-SA (e.g., the MAC addresses of host device 405), CMAC-DA (e.g., the MAC address of destination host device 490c), and CVLAN value. The header of the Ethernet frame may also include the IP address of host device 405 (e.g., SIP) and the IP address of destination host device 490c (e.g., DIP).

At 504, it is determined whether the overlay packet is a unicast packet or not. For example, the edge node may determine whether the overlay packet is a unicast packet or not. For example, once the Ethernet frame of the packet stream is classified in a layer 2 virtual network, CMAC-SA learning may occur by adding the key: {CMAC-SA, VNI} entry into the L2 forwarding table for future lookups. Further, the CMAC-DA may be looked up in the L2 forwarding table, with key: {CMAC-DA, VNI}. If the CMAC-DA indicates the MAC address of the specific known MAC address, network node 415a may determine that the overlay packet is the unicast packet. As shown in FIG. 4A, the CMAC-DA may be the MAC address of the destination host device 490c.

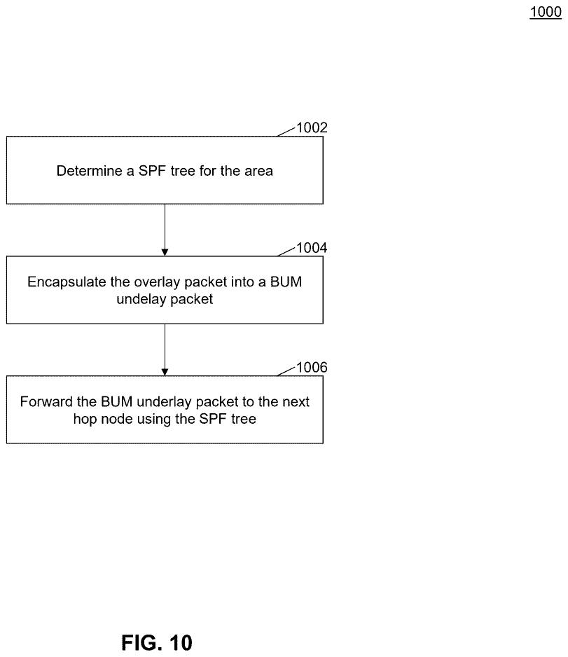

In some aspects, if the CMAC-DA indicates the MAC address of the unknown MAC address, multicast address, or broadcast address, network node 415a may determine that the overlay packet is for the BUM flooding. If the overlay packet is not a unicast packet but a packet for BUM flooding, the operation proceeds to 505, and the processing may proceed to operation 1002, which is explained below in FIG. 10.

In some aspects, prior to the process described above, if the CMAC-DA indicates the MAC address of a local UNI of Ingress BEB (e.g., network node 415a), then the packet stream may be bridged to the local UNI following the UNI-defined rules without processing operation 504 and further operations.

At 506, an inter-area router is determined based on an underlay routing table and an IP address of an end node connected to the destination host device. For example, the edge node may determine an IP address of an end node connected to the destination host device and inter-area router based on an underlay routing table lookup with the IP address of an end node connected to the destination host device. The inter-area router may be determined as a BMAC-DA of the closest inter-area router. For example, network node 415a may determine a BIP-DA, the backbone IP address of the edge node connected to the destination host device (e.g., network node 455d), based on the L2 forwarding table using the CMAC-DA. The edge node connected to the destination host device may be referred to as an Egress BEB or an end node. Then, the BMAC-DA, the MAC address (system ID) of the inter-area router, may be determined based on the underlay routing table programmed by ISIS using the BIP-DA. Various algorithms may be used to calculate distances between network nodes to determine the BMAC-DA. In the case of the equal-cost multipath (ECMP) method is used, the result can be multiple eligible inter-area routers at equal distances, with possibly multiple equal cost paths to each. In that case, a selected hashing algorithm may decide the inter-area router and path, which can be represented by BVLAN ID. The hashing algorithm may be based on a VNI, CMAC-SA, CMAC-DA, overlay source IP address, overlay destination IP address, Ethertype, or a combination thereof. In the example shown in FIG. 4A, inter-area router 480b may be determined as the inter-area router. The operations after 506 may be referenced as a unicast forwarding operation.

In some aspects, prior to the process described above, if the BIP-DA indicates that the destination host is connected to the edge node (e.g., 415c) inside the area where Ingress BEB (network node 415a) belongs to, network node 415a may compute a shortest path forwarding tree including the BMAC-DA of network node 415c and the NNI egress port corresponding to the {BMAC-DA, BVLAN}. Then, network node 415a may forward and encapsulate the packet stream along with the SPF tree without processing operation 506 and further operations.

At 508, an SPF tree from the edge node to the inter-area router is determined. For example, the edge node may determine an SPF tree from the edge node to the inter-area router. For example, the BVLAN ID corresponding to the path used for determining the inter-area router at 506 may be determined as the SPF tree.

At 510, the overlay packet is encapsulated into a unicast underlay packet by adding an underlay header. For example, the edge node may encapsulate the overlay packet into a unicast underlay packet by adding an underlay header. For example, an overlay packet from unicast stream 10 is encapsulated into an underlay packet by network node 415a. In some aspects, the underlay packet may be encapsulated based on a layer 3 virtual network. For example, the layer 3 virtual network may be based on VXLAN, GENEVE, or a comparable virtualization technology. In some aspects, the overlay packet may be encapsulated into an underlay packet by adding an underlay header to the overlay packet. In some aspects, the underlay header may include an underlay Ethernet header, an underlay IP header, and a virtual network identifier (VNI) value. In some aspects, the underlay Ethernet header may include BMAC-DA (MAC address (system ID) of the inter-area router (e.g., inter-area router 480b)), BMAC-SA (MAC address (system ID) of Ingress BEB (e.g., network node 415a), and BVLAN determined by the hashing algorithm. In some aspects, the underlay IP header may include a BIP-DA (IP address (system IP) of Egress BEB (e.g., network node 455d) and BIP-SA (IP address (system IP) of Egress BEB (e.g., network node 455d). The VNI value may be a service ID value corresponding to the virtual network.

At 512, the unicast underlay packet is forwarded to the inter-area router using the SPF tree. For example, the edge node may forward the unicast underlay packet to the inter-area router using the SPF tree. For example, network node 415a may forward the underlay packet through network node 415d to inter-area router 480b according to the SPF tree.

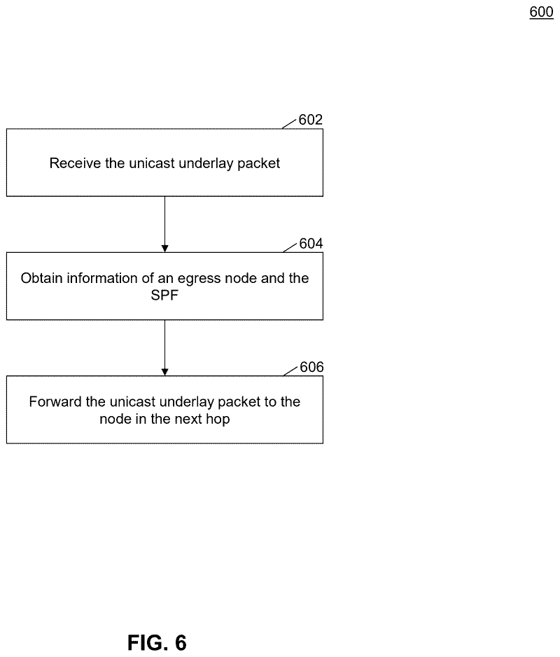

FIG. 6 is a flow chart illustrating a method 600 for bridging the underlay packet, according to some aspects. Method 600 can be employed in aspects of the multi-area networks described herein, such as multi-area network environment 400a. Method 600 will be described with reference to the elements enumerated in FIGS. 3 and 4A; however, method 600 is not limited to these example aspects.

In some aspects, method 600 can be implemented to forward packet stream as described in multi-area network environment 400a. In some aspects, a multi-area network environment, such as environment 400a, may contain a first set of network nodes inside a first area and a second set of network nodes inside a second area, such as areas 410 and 430, respectively. In some aspects of method 600, environment 400a may contain a third set of network nodes inside a third area outside of the first and second areas, such as area 450, and a fourth set of network nodes in a fourth area outside of the first, second, and third areas, such as area 470.

In some aspects, method 600 can be performed by network node 415d. The network node, like network node 415d, which forwards the received underlay packet from NNI to NNI, may be referred to as a backbone core bridge (BCB). Method 600 is explained as an operation of the network node 415, which received the underlay packet from the BEB (network node 415a) forwarded in operation 512.

At 602, the unicast underlay packet is received. For example, network node 415d may receive the unicast underlay packet. For example, network node 415d may receive the encapsulated underlay packet from the network node 415a.

At 604, information of an egress node and the SPF tree is obtained. For example, network node 415d may obtain information of an egress node and the SPF tree from the received underlay packet. The information of the egress node and the SPF tree may be included in BMAC-DA or BVLAN ID of the underlay packet. The information of the egress node and the SPF tree can include the system ID of the egress node (e.g., BMAC-DA (MAC address of inter-area router 480)) and the shortest path ID (e.g., BVLAN ID).

At 606, the unicast underlay packet is forwarded to a node in the next hop. For example, network node 415d may forward the unicast underlay packet to a node in the next hop. For example, network node 415d may determine the node in the next hop by using the key: {BMAC-DA, BVLAN} to lookup in an L2 forwarding table. In some aspects, the L2 forwarding table returns an egress port corresponding to the next node along the shortest path. In some aspects, the {BMAC-DA, BVLAN} entries in the L2 forwarding table are populated by the ISIS protocol according to the computed shortest path tree. Network node 415d may forward the unicast underlay packet by bridging the packet to the determined node in the next hop. In the example shown in FIG. 4A, the node in the next hop may be inter-area router 480b.

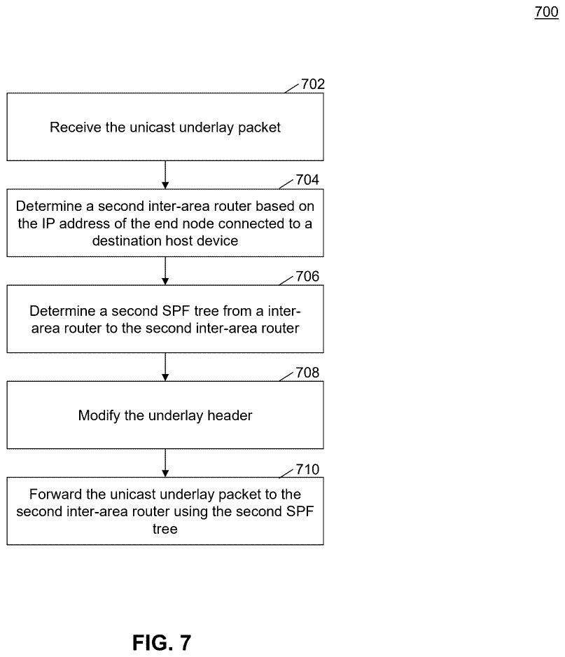

FIG. 7 is a flow chart illustrating a method 700 for routing the underlay packet in a transit area, according to some aspects. Method 700 can be employed in aspects of the multi-area networks described herein, such as multi-area network environment 400a. Method 700 will be described with reference to the elements enumerated in FIGS. 3 and 4A; however, method 700 is not limited to these example aspects.

In some aspects, method 700 can be implemented to forward packet stream as described in multi-area network environment 400a. In some aspects, a multi-area network environment, such as environment 400a, may contain a first set of network nodes inside a first area and a second set of network nodes inside a second area, such as areas 410 and 430, respectively. In some aspects of method 700, environment 400a may contain a third set of network nodes inside a third area outside of the first and second areas, such as area 450, and a fourth set of network nodes in a fourth area outside of the first, second, and third areas, such as area 470.

In some aspects, method 700 can be performed by the inter-area router in the transit area. The area, like area 470, where the destination host device does not exist may be referred to as the transit area. Method 700 is explained as an operation of the inter-area router (e.g., inter-area router 480b) connecting the transit areas that received the underlay packet bridged in operation 606 from the BCB (network node 415d).

At 702, the unicast underlay packet is received. For example, inter-area router 480b may receive the unicast underlay packet. For example, inter-area router 480b may receive the underlay packet from the network node 415d.

At 704, a second inter-area router is determined based on the IP address of the end node connected to the destination host device. For example, inter-area router 480b may determine a second inter-area router based on the BIP-DA of the edge node connected to the destination host device. For example, in response to determining that BMAC-DA is the MAC address of the system ID of inter-area router 480b itself, inter-area router 480b may perform an IP routing table lookup for BIP-DA (IP address of network node 455d). Further, in response to determining that the BIP-DA is not inside the connected areas (areas 410 and 470) but reachable via other inter-area routers, the ISIS instance for the transit area (area 470) may perform the IP routing table lookup with key: {BIP-DA, BVLAN}. Inter-area router 480b may obtain one or multiple equal cost paths that have one or more inter-area routers as the next-hop to the destination area. For example, the paths may include the MAC address of the second inter-area router (e.g., inter-area router 460b), which is determined as BMAC-DA.

At 706, a second SPF tree from the inter-area router (e.g., inter-area router 480b) to the second inter-area router (e.g., inter-area router 460b) is determined. For example, inter-area router 480b may determine a second SPF tree from the inter-area router (e.g., inter-area router 480b) to the second inter-area router (e.g., inter-area router 460b). For example, SPF tree may be selected from one or multiple equal cost using the hashing algorithm, and the path may contain an outgoing NNI and BVLAN ID.

At 708, the underlay header is modified. For example, inter-area router 480b may modify the underlay header. For example, inter-area router 480b may change the BMAC-DA to the MAC address of the second inter-area router (the system ID of inter-area router 460b), BMAC-SA to the MAC address of the inter-area router itself (the system ID of inter-area router 480b), and BVLAN to the BVLAN ID selected at 706. Additionally, a time-to-live (TTL) value of the underlay header is de-incremented.

At 710, the unicast underlay packet is forwarded to the second inter-area router using the second SPF tree. For example, network node 475a may forward the unicast underlay packet to the second inter-area router using the second SPF tree. For example, network node 475a may forward the unicast underlay packet to inter-area router 460b using the SPF tree determined at 706. In some aspects, each time the underlay packet is routed, the TTL value associated with the underlay packet may be de-incremented by 1.

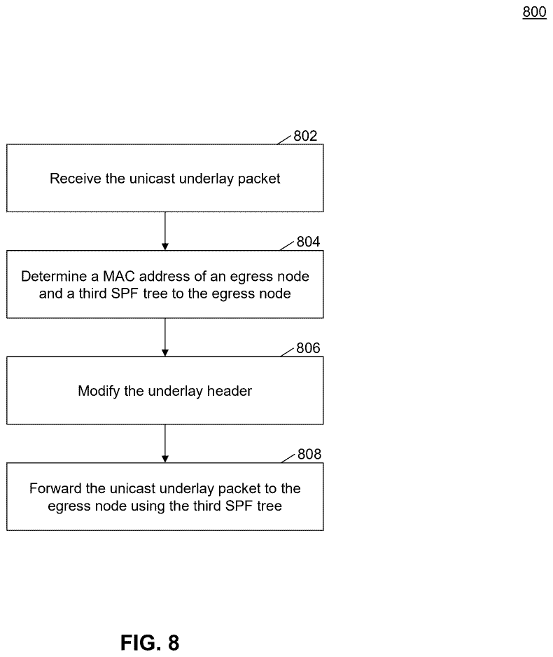

FIG. 8 is a flow chart illustrating a method 800 for routing the underlay packet in a destination area, according to some aspects. Method 800 can be employed in aspects of the multi-area networks described herein, such as multi-area network environment 400a. Method 800 will be described with reference to the elements enumerated in FIGS. 3 and 4A; however, method 800 is not limited to these example aspects.

In some aspects, method 800 can be implemented to forward packet stream as described in multi-area network environment 400a. In some aspects, a multi-area network environment, such as environment 400a, may contain a first set of network nodes inside a first area and a second set of network nodes inside a second area, such as areas 410 and 430, respectively. In some aspects of method 800, environment 400a may contain a third set of network nodes inside a third area outside of the first and second areas, such as area 450, and a fourth set of network nodes in a fourth area outside of the first, second, and third areas, such as area 470.

At 802, the unicast underlay packet is received. For example, inter-area router 460b may receive the unicast underlay packet. As shown in FIG. 4A, the routed underlay packet may initially be received by network node 475a, the BCB in area 470. Then, the routed underlay packet may be bridged by network node 475a r and received by inter-area router 460b.

At 804, the MAC address of an egress node and a third SPF tree to the egress node is determined. For example, inter-area router 460b may determine the MAC address of an egress node and a third SPF tree to the egress node based in BMAC-DA and BIP-DA included in the received underlay packet. For example, in response to determining that BMAC-DA is the MAC address of the system ID of inter-area router 460b itself, inter-area router 480b may perform an IP routing table lookup for BIP-DA (IP address of network node 455d). In some aspects, the IP routing table may be programmed by the ISIS instance of area 450. Inter-area router 460b may obtain one or multiple equal cost paths to the egress node (Egress BEB (e.g., network node 455d)) as next-hop to the destination area. For example, the paths may include the MAC address of the egress node, which is determined as BMAC-DA. Then, the SPF tree may be selected from one or multiple equal cost paths using the hashing algorithm, and the path may contain an outgoing NNI and BVLAN ID.

At 806, the underlay header is modified. For example, inter-area router 460b may modify the underlay header. For example, inter-area router 460b may change the BMAC-DA to the MAC address of Egress BEB (the system ID of network node 455d), BMAC-SA to the MAC address of the inter-area router itself (the system ID of inter-area router 460b), and BVLAN to the BVLAN ID selected at 706. In some aspects, a TTL value of the underlay header is de-incremented.

At 808, the unicast underlay packet is forwarded to the egress node using the third SPF tree. For example, inter-area router 460b may forward the unicast underlay packet to the egress node using the third SPF tree. For example, inter-area router 460b may route the unicast underlay packet to Egress BEB (e.g., inter-area router 460b) using the third SPF tree determined at 804. In some aspects, each time the underlay packet is routed, the TTL value associated with the underlay packet may be de-incremented by 1.

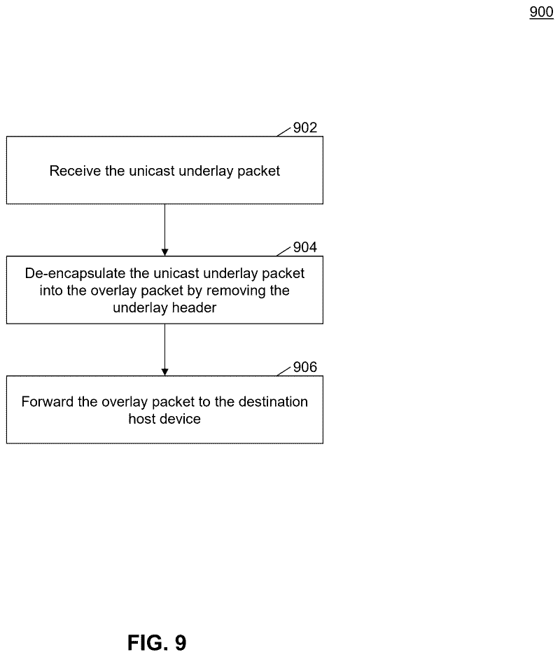

FIG. 9 is a flow chart illustrating a method 900 for forwarding the underlay packet to the destination host device, according to some aspects. Method 900 can be employed in aspects of the multi-area networks described herein, such as multi-area network environment 400a. Method 900 will be described with reference to the elements enumerated in FIGS. 3 and 4A; however, method 900 is not limited to these example aspects.

In some aspects, method 900 can be implemented to forward packet stream as described in multi-area network environment 400a. In some aspects, a multi-area network environment, such as environment 400a, may contain a first set of network nodes inside a first area and a second set of network nodes inside a second area, such as areas 410 and 430, respectively. In some aspects of method 900, environment 400a may contain a third set of network nodes inside a third area outside of the first and second areas, such as area 450, and a fourth set of network nodes in a fourth area outside of the first, second, and third areas, such as area 470.

In some aspects, method 900 is explained as an operation of the Egress node (e.g., network node 455d) connected to the destination host device (e.g., destination host device 490c).

At 902, the unicast underlay packet is received. For example, network node 455d may receive the unicast underlay packet. For example, as shown in FIG. 4A, the underlay packet routed at 808 may be received by network node 455d. In another example, the routed underlay packet may initially be received by another BCB, such as network node 455a. In such a case, the routed underlay packet may be bridged by network node 455a in the same manner explained in method 600 and received by network node 455d.

At 904, the unicast underlay packet is de-encapsulated into the overlay packet by removing the underlay header. For example, network node 455d may de-encapsulate the unicast underlay packet into the overlay packet by removing the underlay header. For example, in response to determining that BMAC-DA corresponds to its own MAC address and BIP-DA corresponds to its own IP address, network node 455d may remove the underlay header and de-encapsulate the unicast underlay packet into the overlay packet.

At 906, the overlay packet is forward to the destination host device. For example, the network node 455d may forward the overlay packet to the destination host device. For example, network node 455d may perform an L2 table CMAC lookup with key: {CMAC-DA, VNI}. The matching entry of the lookup may point to a UNI, providing an egress port and UNI-specific VLAN actions (e.g., remap CVLAN value, add CVLAN value, and remove CVLAN value). Then, network node 455d may forward the overlay packet based on the UNI.

FIG. 10 is a flow chart illustrating a method 1000 for forwarding a BUM traffic packet over a multi-area network, according to some aspects. Method 1000 can be employed in aspects of the multi-area networks described herein, such as multi-area network environment 400b. Method 1000 will be described with reference to the elements enumerated in FIGS. 3 and 4B; however, method 1000 is not limited to these example aspects.

In some aspects, method 1000 can be implemented to forward packet stream as described in multi-area network environments 400b. In some aspects, a multi-area network environment, such as environment 400b, may contain a first set of network nodes inside a first area and a second set of network nodes inside a second area, such as areas 410 and 430, respectively. In some aspects of method 1000, environment 400b may contain a third set of network nodes inside a third area outside of the first and second areas, such as area 450, and a fourth set of network nodes in a fourth area outside of the first, second, and third areas, such as area 470.

In some aspects, the method 1000 may be performed as an operation following operation 504, explained in FIG. 5. For example, in response to the determination that the overlay packet is not a unicast packet, a packet for BUM flooding, the process may proceed to operation 1002. The operations after 1002 may be referenced as a BUM forwarding operation. In some aspects, the method 1000 can be performed by network node 415a.

In some aspects, there is an overall conceptual path tree that spans from the sender node (network node 415a) to all the nodes in the network that participate in environment 400b. The conceptual tree may be comprised of originating area (area 410) subtree, transit area (areas 430 and 470) subtree, and destination area (areas 470 and 490) subtree. The transit area subtree and destination area subtrees may be stitched to the originating area subtree.

At 1002, an SPF tree for the originating area (e.g., area 410) is determined. For example, network node 415a may determine an SPF tree for the originating area (e.g., area 410). In some aspects, flooding of BUM traffic 20 may be done over the L2 virtual network (VNI) based SPF tree belonging to the originating node (network node 415a). For example, there are one or more shortest paths from network node 415a to each of the egress nodes. Each shortest path can be assigned an ID based on a hashing algorithm or comparable unique identifier generator function. The hashing algorithm may be based on a VNI, CMAC-SA, CMAC-DA, overlay source IP address, overlay destination IP address, Ethertype, or a combination thereof. The shortest path ID may correspond to one of the available BVLAN IDs. In some aspects, network node 415a may determine the SPF tree by selecting a BVLAN ID.

In some aspects, there is one shortest path forwarding tree for each node in the network per each unique service ID provided by the underlay network. The shortest path trees are computed based on the ISIS LSDB of the underlay network. For example, network node 415a may use the ISIS protocol to compute a shortest path forwarding tree based on the ISIS LSDB for each network node as the root node. Each shortest path forwarding tree can be uniquely identified by BMAC-DA, which is based on both the nickname of the source (e.g., network node 415a) and the service ID (e.g., VNI). In some aspects, the shortest path can be identified by a {BMAC-DA, B-VLAN ID} pair in an L2 forwarding table, where the BMAC-DA identifies a shortest path forwarding tree, and the BVLAN ID identifies the shortest path among one or more shortest paths.

In some aspects, to achieve a higher network-wide node-scaling, BUM traffic 20 can be forwarded by intermediate nodes (e.g., network node 415b, 415d, and 475a) by routing based on a BIP-SA and BIP-DA according to VNI-based graph of each area pruned using the shortest path forwarding tree corresponding to the originating node. In such a case, the shortest path forwarding tree may be uniquely identified by a Source, Group, VLAN of a (S, G, V) tuple. The SGV value may be represented by an array containing the source IP address of ingress node network node 415a (e.g., BIP-SA), the IP Multicast group address derived from VNI (e.g., BIP-DA), and BVLAN ID. As such, the same tree can be yielded for all source IPs of the area. This type of configuration for achieving the higher network-wide node scaling is referred to as a provider scale configuration.

At 1004, the overlay packet is encapsulated into a BUM underlay packet by adding an underlay header. The underlay header may be a BUM underlay header. For example, network node 415a may encapsulate the overlay packet into a BUM underlay packet by adding a BUM underlay header. In some aspects, adding may mean prepending. The underlay header can include the VNI to identify that the Ethernet frame is using the BUM service and BVLAN ID to identify the shortest path selected by the ingress node. The underlay header can also include BMAC-SA, i.e., the BMAC address of the source node (network node 415a), and BMAC-DA, i.e., the destination group system ID. In some aspects, BMAC-DA can be derived based on the nickname of network node 415a and the VNI. Additionally, the underlay header can include the IP addresses of network node 415a (e.g., BIP-SA) and the IP Multicast group address (e.g., BIP-DA). As non-limiting examples, encapsulation may be performed using VXLAN, GENEVE, or a comparable layer 3 network virtualization technology. In such cases, the underlay network may be based on IPv4 or IPv6 technologies. The overlay network may also be based on IPv4 or IPv6 technologies. In another example, if environment 400b has the provider scale configuration, BMAC-DA can be derived based on the SGV value.

At 1006, the BUM underlay packet is forwarded to the next hop (e.g., network node 415b and 415d) using the SPF tree. For example, network node 415a may forward the BUM underlay packet to the next hop (e.g., network node 415b and 415d) using the SPF tree. The forwarded BUM underlay packet may be bridged to inter-area router 420b and 480b in the substantially same manner explained in operation 606 by the BCBs (network node 415b and 415d). In another example, if the environment 400b has the provider scale configuration, the forwarded BUM underlay packet may be forwarded from network nodes 415b and 415d to inter-area routers 420b and 480b based on the SGV value and IP multicast (IPMC) routing. The forwarded BUM underlay packet may also be forwarded to the destination host device 490a by network node 415d in substantially the same manner as explained in operation 906.

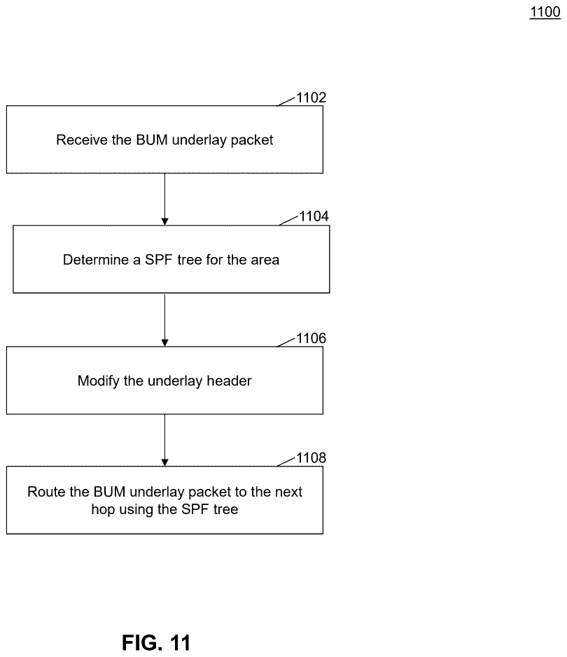

FIG. 11 is a flow chart illustrating a method 1100 for routing BUM traffic packets over a multi-area network, according to some aspects. Method 1100 can be employed in aspects of the multi-area networks described herein, such as multi-area network environment 400b. Method 1100 will be described with reference to the elements enumerated in FIGS. 3 and 4B; however, method 1100 is not limited to these example aspects.

In some aspects, method 1100 can be implemented to forward packet stream as described in multi-area network environments 400b. In some aspects, a multi-area network environment, such as environment 400b, may contain a first set of network nodes inside a first area and a second set of network nodes inside a second area, such as areas 410 and 430, respectively. In some aspects of method 1100, environment 400b may contain a third set of network nodes inside a third area outside of the first and second areas, such as area 450, and a fourth set of network nodes in a fourth area outside of the first, second, and third areas, such as area 470.

In some aspects, method 1100 can be performed by an inter-area router. For example, method 1100 can be performed by inter-area routers 420b and 480b. In some aspects, every inter-area router that leads to the area needing the service has to be a member of the multicast service tree.

At 1102, the BUM underlay packet is received. For example, the inter-area router may receive the BUM underlay packet. For example, inter-area router 420b may receive the BUM underlay packet from network node 415a.

At 1104, an SPF tree for the area where the inter-area router belongs is determined. For example, the inter-area router 420b may determine an SPF tree for the area where the inter-area router 420b belongs, such as areas 410 and 430. For example, the inter-area router 420b may determine the SPF tree based on the nickname and the VNI of the BUM underlay packet. In another example, the SPF tree may be determined based on the SGV value.

At 1106, the underlay header is modified. For example, the inter-area router 420b may modify the underlay header of the received BUM underlay packet from BUM traffic 20. For example, the inter-area router 420b may change the BMAC-DA of the underlay header of the BUM underlay packet according to the SPF tree. The inter-area router 420b may also change BMAC-SA of the underlay header of the BUM underlay packet to the MAC address of the inter-area router 420b itself.

At 1108, the BUM underlay packet is routed to the next hop using the shortest path tree. For example, the inter-area router 420b may route the BUM underlay packet to the next hop using the shortest path tree. For example, inter-area router 420b may route the BUM underlay packet to inter-area router 440b, and inter-area router 480b may route the BUM underlay packet to network node 475a and 475b.

In some aspects, inter-area router 440b may route the BUM underlay packet to the network node 455b. Further, network node 455b may de-encapsulate and forward the BUM underlay packet to the destination host device 490d in substantially the same manner as explained in operation 906.

In some aspects, inter-area router 480b may route the BUM underlay packet to network nodes 475a and 475b. Further, network node 475a may bridge the BUM underlay packet to inter-area router 460b based on the underlay multicast BMAC-DA. In another example, if environment 400b has the provider scale configuration, the BUM underlay packet may be forwarded to inter-area router 460b based on the SGV value and IPMC routing. Network node 475a may also de-encapsulate and forward the BUM underlay packet to destination host device 490b in substantially the same manner as explained in operation 906.

In some aspects, inter-area router 460b may route the BUM underlay packet to the network node 455d. Further, network node 455d may de-encapsulate and forward the BUM underlay packet to the destination host device 490c in substantially the same manner as explained in operation 906.

As explained above, by using a link state routing protocol for the control plane and layer 3 network virtualization technology for the data plane, SPBX can natively support multi-area support for SPB. Further, SPBX also can support any topology, including area-loops. Also, SPBX does not need virtual nodes for implementation. Similarly, SPBX does not need CMAC synchronization between the inter-area routers.

In some aspects, as explained above, SPBX can achieve transparent redistribution of all SPB services (bridged, routed, multicast, IPv4/IPv6) with full control of redistribution by the user. SPBX can also use up to one million nodes in its environment with the ability to use unique multicast trees across all areas for every service on every source node and underlay IP address as the nickname. If SPBX uses the provider scale configuration, it can use more than one million nodes by using underlay SGV value lookups for each unique multicast tree.

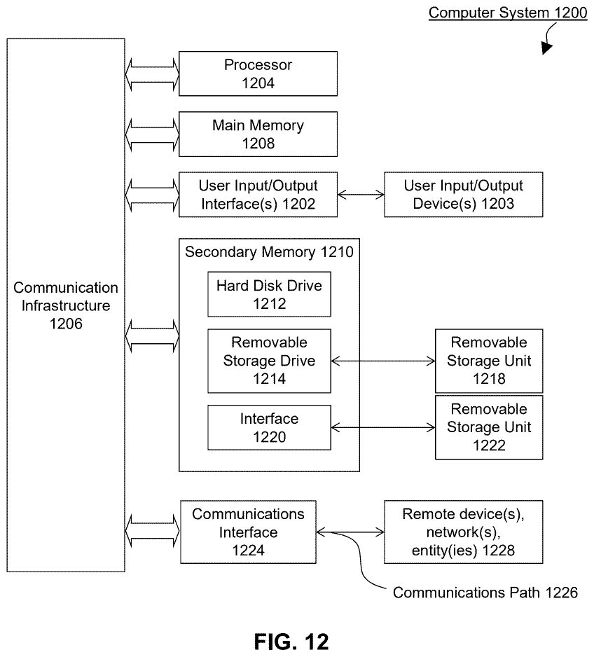

FIG. 12 illustrates a diagram of a general-purpose computer that can be used to perform various aspects of the present disclosure, according to some aspects. Various aspects can be implemented, for example, using one or more well-known computer systems, such as computer system 1200 shown in FIG. 12. One or more computer systems 1200 can be used, for example, to implement any aspect of the disclosure discussed herein, such as control plane system 300 and IP multicast stream environments 400a and 400b, as well as any combinations and sub-combinations thereof.

Computer system 1200 can include one or more processors (also called central processing units, or CPUs), such as a processor 1204. Processor 1204 can be connected to a communication infrastructure or bus 1206.

Computer system 1200 can also include customer input/output device(s) 1203, such as monitors, keyboards, pointing devices, etc., which can communicate with communication infrastructure 1206 through customer input/output interface(s) 1202.

One or more of processors 1204 can be a graphics processing unit (GPU). In an aspect, a GPU can be a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 1200 can also include a main or primary memory 1208, such as random access memory (RAM). Main memory 1208 can include one or more levels of cache. Main memory 1208 can have stored therein control logic (i.e., computer software) and/or data.

Computer system 1200 can also include one or more secondary storage devices or memory 1210. Secondary memory 1210 can include, for example, a hard disk drive 1212 and/or a removable storage device or drive 1214. Removable storage drive 1214 can be a floppy disk drive, a magnetic tape drive, a compact disk drive, an optical storage device, tape backup device, and/or any other storage device/drive.

Removable storage drive 1214 can interact with a removable storage unit 1218. Removable storage unit 1218 can include a computer usable or readable storage device having stored thereon computer software (control logic) and/or data. Removable storage unit 1218 can be a floppy disk, magnetic tape, compact disk, DVD, optical storage disk, and/any other computer data storage device. Removable storage drive 1214 can read from and/or write to removable storage unit 1218.

Secondary memory 1210 can include other means, devices, components, instrumentalities or other approaches for allowing computer programs and/or other instructions and/or data to be accessed by computer system 1200. Such means, devices, components, instrumentalities or other approaches can include, for example, a removable storage unit 1222 and an interface 1220. Examples of the removable storage unit 1222 and the interface 1220 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 can further include a communication or network interface 1224. Communication interface 1224 can enable computer system 1200 to communicate and interact with any combination of external devices, external networks, external entities, etc. (individually and collectively referenced by reference number 1228). For example, communication interface 1224 can allow computer system 1200 to communicate with external or remote devices 1228 over communications path 1226, which can be wired and/or wireless (or a combination thereof), and which can include any combination of LANs, WANs, the Internet, etc. Control logic and/or data can be transmitted to and from computer system 1200 via communication path 1226.

Computer system 1200 can also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1200 can be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1200 can be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas can be used, either exclusively or in combination with known or open standards.

In some aspects, a tangible, non-transitory apparatus or article of manufacture including a tangible, non-transitory computer useable or readable medium having control logic (software) stored thereon can also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200), can cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 12. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References herein to “one aspect,” “an aspect,” “an example aspect,” “some aspects,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

These and other valuable aspects of the aspects of the present disclosure consequently further the state of the technology to at least the next level. While the disclosed aspects have been described as the best mode of implementing the multi-area SPBX network for overlay IP streams, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the breadth and scope of this disclosure should not be limited by any of the above-described exemplary aspects, but should be defined only in accordance with the following claims and their equivalents.

What is claimed is:

1. A method for forwarding an overlay packet across a multi-area network comprising a first area including a first set of network nodes and a second area including a second set of network nodes outside of the first area, the method comprising:
receiving, by an edge node in the first set of network nodes and from a first host device, the overlay packet; and
in response to determining, by the edge node, that the overlay packet is a unicast packet intended for a second host device, performing a unicast forwarding operation, wherein the unicast forwarding operation comprising:
determining, by the edge node:
an IP address of an end node connected to the second host device;
an inter-area router based on an underlay routing table lookup with the IP address of the end node connected to the second host device, wherein the inter-area router is included in the first area and the second area, and the underlay routing table is created by the edge node based on a link state routing protocol; and
a shortest path forwarding tree from the edge node to the inter-area router;
encapsulating, by the edge node, the overlay packet into a unicast underlay packet by adding an underlay header, wherein the underlay header comprises a media access control (MAC) address of the inter-area router, a MAC address of the edge node, the IP address of the end node, an IP address of the edge node, and an identifier of the shortest path forwarding tree; and
forwarding, by the edge node, the unicast underlay packet to the inter-area router using the shortest path tree.

2. The method of claim 1, further comprising:
receiving, by the edge node, a second unicast underlay packet from the inter-area router, wherein the second unicast underlay packet is encapsulated with a second underlay header, wherein the second underlay header comprises the MAC address of the inter-area router, a MAC address of the edge node, the IP address of the edge node, an IP address of an ingress edge node, and second identifier of a second shortest path forwarding tree;
de-encapsulating, by the edge node, the second unicast underlay packet into the overlay packet by removing the second underlay header; and
forwarding, by the edge node, the overlay packet to the first host device.

3. The method of claim 1, further comprising:
in response to determining, by the edge node, that the overlay packet is a broadcast, unknown unicast, and multicast (BUM) traffic packet intended for flooding, performing a BUM forwarding operation, wherein the BUM forwarding operation comprising:
determining, by the edge node, a second shortest path forwarding tree for the first area based multicast destination nodes subject to the flooding wherein the second shortest path forwarding tree is identified by a nickname of the edge node, and a service identifier (ID) of a virtual network corresponding to the multi-area network;
encapsulating, by the edge node, the overlay packet into a BUM underlay packet by adding a BUM underlay header; and
forwarding, by the edge node, the BUM underlay packet to the inter-area router using the second shortest path trees.

4. The method of claim 1, further comprising:
in response to determining, by the edge node, that the overlay packet is a broadcast, unknown unicast, and multicast (BUM) traffic packet intended for flooding, performing a BUM forwarding operation, wherein the BUM forwarding operation comprising:
determining, by the edge node, a second shortest path forwarding tree for the first area based multicast destination nodes subject to the flooding wherein the second shortest path forwarding tree is identified by an IP address of the edge node, a multicast address, and a service identifier (ID) of a virtual network corresponding to the multi-area network;
encapsulating, by the edge node, the overlay packet into a BUM underlay packet by adding a BUM underlay header; and
forwarding, by the edge node, the BUM underlay packet to the inter-area router using the second shortest path trees.

5. The method of claim 1, further comprising:
receiving, by the edge node and from the inter-area router, route information of the second set of network nodes, wherein the underlay routing table is created at least based on the route information.

6. The method of claim 1, wherein the link state routing protocol is an Intermediate System to Intermediate System (ISIS) link state protocol.

7. The method of claim 1, wherein the identifier of the shortest path forwarding tree comprises a backbone virtual local area network (BVLAN) identification (ID).

8. A system for forwarding an overlay packet across a multi-area network comprising a first area including a first set of network nodes and a second area including a second set of network nodes outside of the first area, the system comprising:
an edge node in the first set of network nodes configured to perform operations comprising:
receiving, from a first host device, the overlay packet; and
in response to determining, by the edge node, that the overlay packet is a unicast packet intended for a second host device, performing a unicast forwarding operation, wherein the unicast forwarding operation comprising:
determining:
an IP address of an end node connected to the second host device;
an inter-area router based on an underlay routing table lookup with the IP address of the end node, wherein the inter-area router is included in the first area and the second area, and the underlay routing table is created by the edge node based on a link state routing protocol; and
a shortest path forwarding tree from the edge node to the inter-area router;
encapsulating the overlay packet into a unicast underlay packet by adding an underlay header, wherein the underlay header comprises a media access control (MAC) address of the inter-area router, a MAC address of the edge node, an IP address of the end node, an IP address of the edge node, and an identifier of the shortest path forwarding tree; and
forwarding the unicast underlay packet to the inter-area router using the shortest path tree.

9. The system of claim 8, the operations further comprising:
receiving a second unicast underlay packet from the inter-area router, wherein the second unicast underlay packet is encapsulated with a second underlay header, wherein the second underlay header comprises the MAC address of the inter-area router, a MAC address of the edge node, the IP address of the edge node, an IP address of an ingress edge node, and second identifier of a second shortest path forwarding tree;
de-encapsulating the second unicast underlay packet into the overlay packet by removing the second underlay header; and
forwarding the overlay packet to the first host device.

10. The system of claim 8, the operations further comprising:
in response to determining that the overlay packet is a broadcast, unknown unicast, and multicast (BUM) traffic packet intended for flooding, performing a BUM forwarding operation, wherein the BUM forwarding operation comprising:
determining a second shortest path forwarding tree for the first area based multicast destination nodes subject to the flooding wherein the second shortest path forwarding tree is identified by a nickname of the edge node, and a service identifier (ID) of a virtual network corresponding to the multi-area network;
encapsulating the overlay packet into a BUM underlay packet by adding a BUM underlay header; and
forwarding the BUM underlay packet to the inter-area router using the second shortest path trees.

11. The system of claim 8, the operations further comprising:
in response to determining that the overlay packet is a broadcast, unknown unicast, and multicast (BUM) traffic packet intended for flooding, performing a BUM forwarding operation, wherein the BUM forwarding operation comprising:
determining a second shortest path forwarding tree for the first area based multicast destination nodes subject to the flooding wherein the second shortest path forwarding tree is identified by an IP address of the edge node, a multicast address, and a service identifier (ID) of a virtual network corresponding to the multi-area network;
encapsulating the overlay packet into a BUM underlay packet by adding a BUM underlay header; and
forwarding the BUM underlay packet to the inter-area router using the second shortest path trees.

12. The system of claim 8, the operations further comprising:
receiving route information of the second set of network nodes, wherein the underlay routing table is created at least based on the route information from the inter-area router.

13. The system of claim 8, wherein the link state routing protocol is an Intermediate System to Intermediate System (ISIS) link state protocol.

14. The system of claim 8, wherein the identifier of the shortest path forwarding tree comprises a backbone virtual local area network (BVLAN) identification (ID).

15. A non-transitory computer readable medium storing instructions for forwarding an overlay packet across a multi-area network comprising a first area including a first set of network nodes and a second area including a second set of network nodes outside of the first area that, when executed by an edge node in the first set of network nodes, cause the edge node to perform operations comprising:
receiving, from a first host device, the overlay packet; and
in response to determining, by the edge node, that the overlay packet is a unicast packet intended for a second host device, performing a unicast forwarding operation, wherein the unicast forwarding operation comprising:
determining:
an IP address of an end node connected to the second host device;
an inter-area router based on an underlay routing table lookup with the IP address of the end node, wherein the inter-area router is included in the first area and the second area, and the underlay routing table is created by the edge node based on a link state routing protocol; and
a shortest path forwarding tree from the edge node to the inter-area router;
encapsulating the overlay packet into a unicast underlay packet by adding an underlay header, wherein the underlay header comprises a media access control (MAC) address of the inter-area router, a MAC address of the edge node, an IP address of the end node, an IP address of the edge node, and an identifier of the shortest path forwarding tree; and
forwarding the unicast underlay packet to the inter-area router using the shortest path tree.

16. The non-transitory computer readable medium of claim 15, the operations further comprising:
receiving a second unicast underlay packet from the inter-area router, wherein the second unicast underlay packet is encapsulated with a second underlay header, wherein the second underlay header comprises the MAC address of the inter-area router, a MAC address of the edge node, the IP address of the edge node, an IP address of an ingress edge node, and second identifier of a second shortest path forwarding tree;
de-encapsulating the second unicast underlay packet into the overlay packet by removing the second underlay header; and
forwarding the overlay packet to the first host device.

17. The non-transitory computer readable medium of claim 15, the operations further comprising:
in response to determining that the overlay packet is a broadcast, unknown unicast, and multicast (BUM) traffic packet intended for flooding, performing a BUM forwarding operation, wherein the BUM forwarding operation comprising:
determining a second shortest path forwarding tree for the first area based multicast destination nodes subject to the flooding wherein the second shortest path forwarding tree is identified by a nickname of the edge node, and a service identifier (ID) of a virtual network corresponding to the multi-area network;
encapsulating the overlay packet into a BUM underlay packet by adding a BUM underlay header; and
forwarding the BUM underlay packet to the inter-area router using the second shortest path trees.

18. The non-transitory computer readable medium of claim 15, the operations further comprising:
in response to determining that the overlay packet is a broadcast, unknown unicast, and multicast (BUM) traffic packet intended for flooding, performing a BUM forwarding operation, wherein the BUM forwarding operation comprising:
determining a second shortest path forwarding tree for the first area based multicast destination nodes subject to the flooding wherein the second shortest path forwarding tree is identified by an IP address of the edge node, a multicast address, and a service identifier (ID) of a virtual network corresponding to the multi-area network;
encapsulating the overlay packet into a BUM underlay packet by adding a BUM underlay header; and
forwarding the BUM underlay packet to the inter-area router using the second shortest path trees.

19. The non-transitory computer readable medium of claim 15, the operations further comprising:
receiving route information of the second set of network nodes, wherein the underlay routing table is created at least based on the route information from the inter-area router.

20. The non-transitory computer readable medium of claim 15, wherein the link state routing protocol is an Intermediate System to Intermediate System (ISIS) link state protocol.
